(19) United States
(12) Patent Application Publication
(10) Pub. No.: US 2018/0275803 A1
(43) Pub. Date: Sep. 27, 2018

(54) TOUCH-PANEL-EQUIPPED DISPLAY DEVICE

(71) Applicant: SHARP KABUSHIKI KAISHA, Sakai City, Osaka (JP)

(72) Inventor: JUN MAEDA, Sakai City (JP)

(21) Appl. No.: 15/781,525

(22) PCT Filed: Dec. 5, 2016
(86) PCT No.: PCT/JP2016/086002

§ 371 Date: Jun. 5, 2018

(30) Foreign Application Priority Data
Dec. 7, 2015 (JP) 2015-238190

(51) Int. Cl. G06F 3/041; G02F 1/1333; G02F 1/1335

(52) U.S. Cl. CPC G06F 3/0412; G02F 1/13338; G02F 2202/28; G02F 1/133308; G02F 1/133512

(57) ABSTRACT

Provided is a touch-panel-equipped display device in which a positional displacement can be prevented from occurring to a touch panel bonded to a display panel. A touch-panel-equipped display device 1 includes a display panel 13, a touch panel 11, and a bonding mechanism 12 for bonding the display panel 13 and the touch panel 11 to each other. The bonding mechanism 12 includes a first bonding layer 121a that has translucency and is bonded on a surface of the display panel 13, the surface being opposed to the touch panel 11; a second bonding layer 121b that has translucency and is bonded on a surface of the touch panel 11, the surface being opposed to the display panel 13; and a support member 122 that is interposed between the first bonding layer 121a and the second bonding layer 121b, and supports the touch panel 11.

### TECHNICAL FIELD

The present invention relates to a touch-panel-equipped display device.

### BACKGROUND ART

In recent years, a touch-panel-equipped display device provided with a display panel and a touch panel on the front surface of the display panel has been in widespread use, and a variety of techniques for bonding a display panel and a touch panel have been proposed.

JP-A-2012-93667 discloses a touch-panel-equipped display device in which a touch panel is arranged on a front surface of a display panel, and a protection plate is provided on a front surface of the touch panel. This touch-panel-equipped display device has the following configuration: a step part is formed on an outer circumference part of the protection plate, a touch panel is bonded on a back surface of the protection plate that includes the step part, with an optical elastic resin being interposed therebetween, and the display panel is bonded on a back surface of the touch panel, with an optical elastic resin being interposed therebetween.

### SUMMARY OF THE INVENTION

Incidentally, there are some cases where the protection plate is not provided on the front surface of the touch panel and the touch panel is arranged on the frontmost surface. FIG. 15A illustrates a cross-sectional view in a case where such a touch-panel-equipped display device is arranged vertically. As illustrated in FIG. 15A, the touch-panel-equipped display device 100 has the following configuration: touch panel 101 is bonded to a front surface of a display panel 103 that has a back surface to which a backlight 104 is bonded, with a bonding layer 102 being interposed between the touch panel 101 and the display panel 103. In such a bonding structure, the touch panel 101 has a reduced bonding intensity particularly in high-temperature environments, and the touch panel 101 is displaced in the gravity direction (in the Z axis negative direction) in some cases.

In a case where the size of the touch panel 101 is approximately equal to the size of the display panel 103, however, an outer edge part of the touch panel 101 and the display panel 103 that are bonded to each other may be covered with a cover 110, as illustrated in FIG. 15B for example, so that the touch panel 101 and the display panel 103 are fixed, whereby such a displacement of the touch panel 101 can be prevented. In a case where the size of the touch panel 101 is greater than that of the display panel 103, however, it is difficult to cover the outer edge part of the touch panel 101 and the display panel 103 with the cover 110, which makes it unable to fix the touch panel 101 and the display panel 103 to each other. Further, even in a case where the size of the touch panel 101 is approximately equal to the size of the display panel 103, if the area for engaging the touch panel 101 with the exterior part is narrow when the touch panel 101 is combined with another exterior part, the touch panel 101 and the display panel 103 cannot be covered with the cover 110.

It is an object of the present invention to provide a touch-panel-equipped display device in which a positional displacement can be prevented from occurring to a touch panel bonded to a display panel.

A touch-panel-equipped display device in one embodiment of the present invention includes: a display panel; a touch panel arranged so as to be opposed to the display panel; and a bonding mechanism for bonding the display panel and the touch panel to each other, wherein the bonding mechanism includes: a first bonding layer that has translucency and is bonded on a surface of the display panel, the surface being opposed to the touch panel; a second bonding layer that has translucency and is bonded on a surface of the touch panel, the surface being opposed to the display panel; and a support member that is interposed between the first bonding layer and the second bonding layer, and supports the touch panel.

With the embodiment of the present invention, it is possible to prevent a positional displacement from occurring to the touch panel bonded to the display panel.

### BRIEF DESCRIPTION OF DRAWINGS

FIG. 1 is a schematic diagram illustrating a back surface of a touch-panel-equipped display device according to Embodiment 1.

FIG. 2 is a schematic diagram illustrating a cross section of the touch-panel-equipped display device illustrated in FIG. 1, taken along line I-I.

FIG. 3 is a schematic diagram illustrating a top surface of the touch-panel-equipped display device illustrated in FIG. 1.

FIG. 4A is a schematic diagram illustrating a configuration of a support member illustrated in FIG. 2.

FIG. 4B is a schematic diagram of the support member illustrated in FIG. 4A, viewed from the Y axis positive direction.

FIG. 5 is a schematic diagram illustrating a back surface of a touch-panel-equipped display device according to Embodiment 2.

FIG. 6 is a schematic diagram illustrating a cross section of the touch-panel-equipped display device illustrated in FIG. 5, taken along line II-II.

FIG. 7 is a schematic diagram illustrating a top surface of the touch-panel-equipped display device 1A illustrated in FIG. 5.

FIG. 8A is a schematic diagram illustrating a configuration of a support member illustrated in FIG. 6.

FIG. 8B is a schematic diagram of the support member illustrated in FIG. 8A, viewed from the Y axis positive direction.

FIG. 9 is a schematic diagram illustrating a back surface of a touch-panel-equipped display device according to Embodiment 3.

FIG. 10 is a schematic diagram illustrating a cross section of the touch-panel-equipped display device illustrated in FIG. 9, taken along line III-III.

FIG. 11 is a schematic diagram illustrating a top surface of the touch-panel-equipped display device illustrated in FIG. 9.

FIG. 12A is a schematic diagram illustrating a configuration of a support member illustrated in FIG. 10.

FIG. 12B is a schematic diagram of the support member 322 illustrated in FIG. 12A, viewed from the Y axis positive direction.

FIG. 13 is a schematic diagram illustrating a cross section of a support member in Modification Example (1).

FIG. 14A is a plan view schematically illustrating an exemplary bonding layer in Modification Example (2).

FIG. 14B is a cross-sectional view and a plan view schematically illustrating another exemplary bonding layer in Modification Example (2).

FIG. 15A is a cross-sectional view schematically illustrating a bonding structure for bonding a touch panel and a display panel to each other in a conventional touch-panel-equipped display device.

FIG. 15B is a schematic diagram illustrating a state in which the touch-panel-equipped display device illustrated in FIG. 15A is covered with a cover.

### MODE FOR CARRYING OUT THE INVENTION

A touch-panel-equipped display device in one embodiment of the present invention includes: a display panel; a touch panel arranged so as to be opposed to the display panel; and a bonding mechanism for bonding the display panel and the touch panel to each other, wherein the bonding mechanism includes: a first bonding layer that has translucency and is bonded on a surface of the display panel, the surface being opposed to the touch panel; a second bonding layer that has translucency and is bonded on a surface of the touch panel, the surface being opposed to the display panel; and a support member that is interposed between the first bonding layer and the second bonding layer, and supports the touch panel (the first configuration).

According to the first configuration, the display panel is bonded to the first bonding layer, and the touch panel is bonded to the second bonding layer, and further, the touch panel is supported by the support member interposed between the first bonding layer and the second bonding layer. With this configuration, even if the bonding intensity of the touch panel decreases, a positional displacement hardly occurs to the touch panel.

The first configuration may be further characterized in that the support member includes: an interposed part that is interposed between the first bonding layer and the second bonding layer, outside a display area of the display panel; an extension part that is not interposed between the first bonding layer and the second bonding layer, and is extended from an end of the interposed part; and a support part that is connected to the extension part, and supports at least a lower end of the touch panel (the second configuration).

According to the second configuration, the support member includes the interposed part, the extension part, and the support part. Each of these parts is arranged outside the display area, and the lower end of the touch panel is supported by the support part. This makes it possible to prevent a positional displacement from occurring to the touch panel, without the support member reducing the visibility of the display area.

The first configuration may be further characterized in that a length of the second bonding layer in one direction of the touch panel is greater than that of the first bonding layer, and the support member includes: an interposed part that is interposed between the first bonding layer and the second bonding layer, in an area outside a display area of the display panel; an extension part that is not interposed between the first bonding layer and the second bonding layer, and is extended from an end of the interposed part in the one direction; and a support part that is connected to the extension part, and has a protrusion combined with an external component (the third configuration).

According to the third configuration, the length of the second bonding layer in one direction of the touch panel is greater than that of the first bonding layer. In other words, the second bonding layer has an area greater than that of the first bonding layer. This allows the touch panel to have a greater area bonded to the second bonding layer, thereby having a greater bonding intensity, as compared with a case where the first bonding layer and the second bonding layer have approximately equal areas. Further, the support member includes the interposed part, the extension part, and the support part, each of which is arranged outside of the display area, and the support member is fixed to an external component, with the support part being interposed therebetween. This makes it possible to prevent a positional displacement from occurring to the touch panel, without the support member reducing visibility of the display area.

Any one of the first to third configurations may be further characterized in that the first bonding layer and the second bonding layer are provided on an inner side with respect to an outer edge of the display panel, outside a display area of the display panel (the fourth configuration).

According to the fourth configuration, the range where the first bonding layer and the second bonding layer are provided can be reduced to a minimum, as compared with a case where each of the first bonding layer and the second bonding layer has the same size as that of the display surface of the display panel.

Any one of the first to fourth configurations may be further characterized in that the display panel includes a liquid crystal layer, and the touch-panel-equipped display device further includes: a light source that is bonded on a surface of the display panel, the surface being on a side opposite to the touch panel, the light source irradiating the display panel with light (the fifth configuration).

With the fifth configuration, it is possible to prevent a positional displacement from occurring to the touch panel of the touch-panel-equipped display device in which liquid crystal is used.

Any one of the first to fifth configurations may be further characterized in that the touch panel includes a light-shielding part on the surface thereof opposed to the display panel, in an area on an outer side with respect to the display area of the display panel (the sixth configuration).

According to the sixth configuration, the light-shielding section is provided on the surface of the touch panel opposed to the display panel, whereby the visibility of the display area can be improved.

The following description describes embodiments of the present invention in detail, while referring to the drawings. Identical or equivalent parts in the drawings are denoted by the same reference numerals, and the descriptions of the same are not repeated. To make the description easy to understand, in the drawings referred to hereinafter, the configurations are simply illustrated or schematically illustrated, or the illustration of a part of constituent members is omitted. Further, the dimension ratios of the constituent members illustrated in the drawings do not necessarily indicate the real dimension ratios.

### Embodiment 1

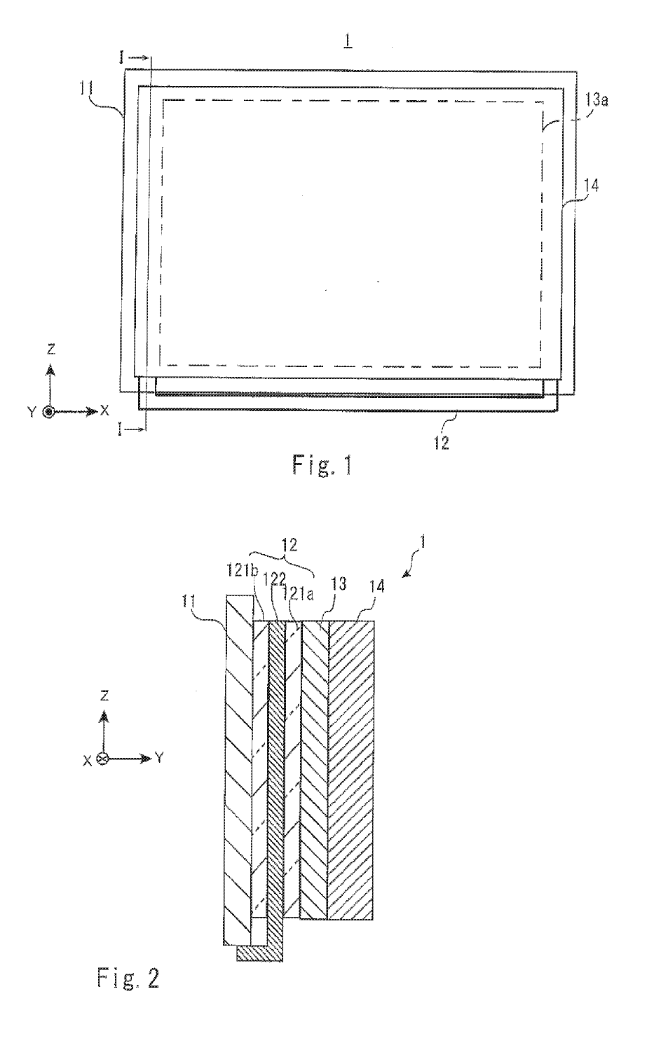

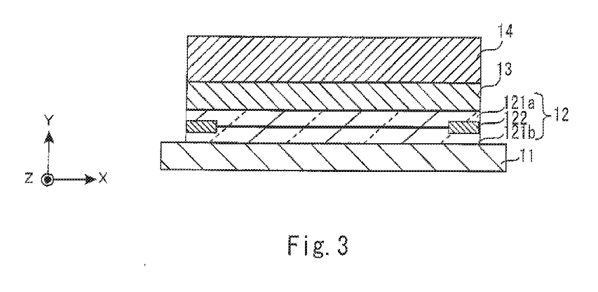

FIGS. 1 to 3 are schematic diagrams illustrating a schematic configuration of a touch-panel-equipped display device according to Embodiment 1 of the present invention. FIG. 1 is a schematic diagram illustrating a back surface of the touch-panel-equipped display device. FIG. 2 is a schematic diagram illustrating a cross section of the touch-panel-equipped display device 1 illustrated in FIG. 1, taken along line I-I. FIG. 3 is a schematic diagram illustrating a top surface (a surface on a side in the Z axis positive direction) of the touch-panel-equipped display device 1 illustrated in FIG. 1. In this example, the posture of the touch-panel-equipped display device 1 illustrated in FIG. 2 is a posture of the same in a state in which it is usually used.

As illustrated in FIGS. 1 to 3, the touch-panel-equipped display device 1 includes a touch panel 11, a bonding part (bonding mechanism) 12, a display panel 13, and a backlight 14.

As illustrated in FIGS. 2 and 3, the touch-panel-equipped display device 1 has the following configuration: the backlight 14 is bonded to the back surface (a surface on a side in the Y axis positive direction) of the display panel 13, and display panel 13 and the touch panel 11 are bonded to each other with the bonding part 12 being interposed therebetween. The bonding part 12 includes bonding layers 121a, 121b and a support member 122. The bonding layer 121a is formed over an approximately entirety of the display surface (the surface on a side in the Y axis negative direction) of the display panel 13, and the bonding layer 121b is formed at a position opposed to the bonding layer 121a, on the back surface (the surface on a side in the Y axis positive direction) of the touch panel 11. As illustrated in FIG. 2, the support member 122 is interposed between the bonding layer 121a and the bonding layer 121b, and a lower end part of the touch panel 11, that is, one edge thereof in the Z axis negative direction, is supported by the support member 122. The following description describes configurations of the respective parts, while referring to FIGS. 1 to 3.

The display panel 13 includes an active matrix substrate having a display area 13a (see FIG. 1) composed of a plurality of pixels, a counter substrate, a liquid crystal layer interposed between the active matrix substrate and the counter substrate, and a pair of polarizing plates (none of the same illustrated). Outside the display panel 13, a driving circuit (not illustrated) for driving each pixel in the display area 13a is provided. In this example, the display panel 13 has the following size: the dimension in the horizontal direction (in the X axis direction), the dimension in the vertical direction (in the Z axis direction), and the dimension in the thickness direction (in the Y axis direction) are 150 mm, 95 mm, and 1.4 mm, respectively.

The backlight 14 is bonded to the back surface of the display panel 13. The backlight 14 includes a light source, and projects light toward the back surface of the display panel 13.

The touch panel 11 is, for example, an electrostatic capacitance type touch panel. In this example, the touch panel 11 has the following size: the dimension in the horizontal direction (in the X axis direction), the dimension in the vertical direction (in the Z axis direction), and the dimension in the thickness direction (in the Y axis direction) are 180 mm, 110 mm, and 1.2 mm, respectively. Thus, the size of the touch panel 11 is greater than the size of the display panel 13. The touch panel 11 has the following configuration: a sensor pattern formed with transparent conductive films made of ITO or the like is formed on a substrate made of glass or the like that is transparent and insulative, and is connected with a circuit board (not illustrated) such as a flexible printed circuit (FPC) and the like, provided outside. Further, in an area positioned outside the display area 13a of the display panel 13 on the touch panel 11, a light-shielding film (not illustrated) of black color or the like is formed, so that the sensor pattern of the touch panel 11 is not visible.

The bonding layers 121a, 121b contain a photocurable resin having transparency. As illustrated in FIGS. 2 and 3, the bonding layer 121a is formed over an entire display surface of the display panel 13. Further, the bonding layer 121b is provided so as to be opposed to the bonding layer 121a on the back surface of the touch panel 11, and the area of the bonding layer 121b is approximately equal to that of the bonding layer 121a. Each of the bonding layers 121a, 121b has a thickness (in the Y axis direction) of about 0.3 mm. In this example, a transparent elastomer that is cured when it is irradiated with ultraviolet light is used as the photocurable resin, and the time for irradiating the ultraviolet light is set to about 200 seconds.

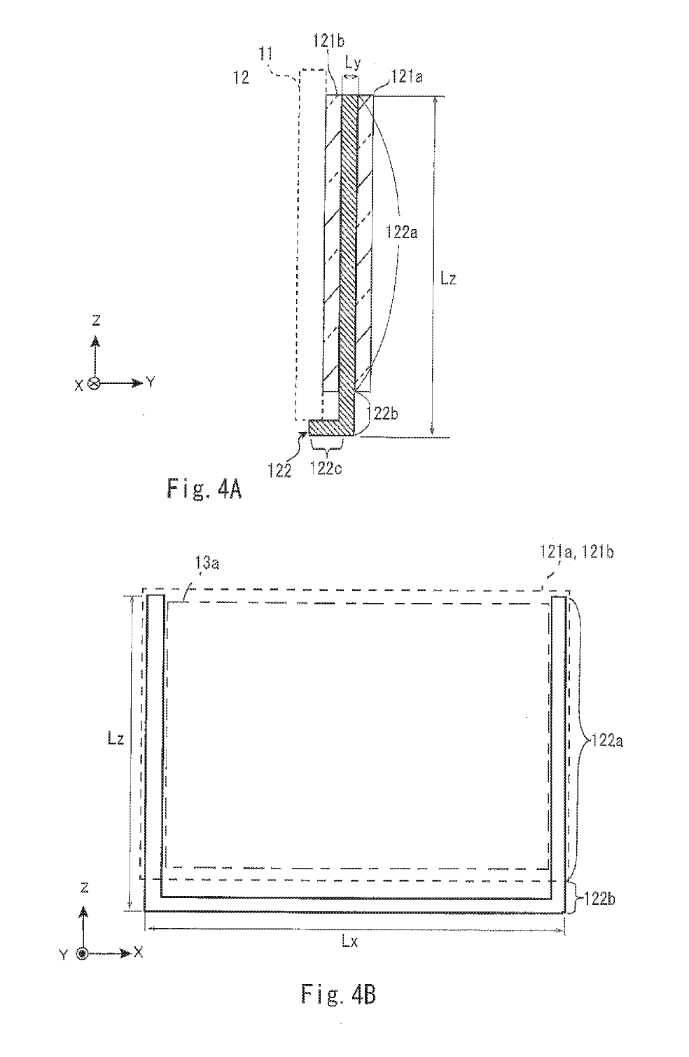

The support member 122 contains, for example, a metal material such as stainless steel material, but the material thereof is not limited to this. As illustrated in FIG. 4A, the support member 122 includes an interposed part 122a, an extension part 122b, and a support part 122c. The interposed part 122a is interposed between the bonding layer 121a and the bonding layer 121b. The extension part 122b is extended from an end of the interposed part 122a in the Z axis negative direction. The support part 122c is connected to the extension part 122b, and is extended toward a lower end part (an end in the Z axis negative direction) of the touch panel 11, so as to support an approximate entirety of the lower end part of the touch panel 11.

FIG. 4B is a schematic diagram of the support member 122 illustrated in FIG. 4A, viewed from the Y axis positive direction. The interposed part 122a is arranged in an area outside the display area 13a of the display panel 13, between the bonding layers 121a and 121b. As illustrated in FIG. 4B, the extension part 122b and the support part 122c are arranged outside the bonding layers 121a, 121b. The support part 122c is provided continuously in the X axis direction, so as to support an approximate entirety of the lower end part of the touch panel 11. In this example, the support member 122 has a length Lx in the X axis direction of about 170 mm, a length Lz in the Z axis direction of about 85 mm, and a length Ly in the Y axis direction in the interposed part 122a of about 1.5 mm.

Incidentally, in this example, the support part 122c is provided continuously in the X axis direction so as to support an approximate entirety of the lower end part of the touch panel 11, but the shape of the support part 122c is not limited to this. For example, the support part 122c may have such a configuration that both ends of the lower end part of the touch panel 11 are supported, or alternatively, such a configuration that three parts that are both ends of the lower end part and a part in the vicinity of the center of the lower end part are supported. In short, the support part 122c may be extended from the extension part 122b toward the lower end part of the touch panel 11, in such a manner that at least a part of the lower end part of the touch panel 11 is supported.

The bonding mechanism for bonding the display panel 13 and the touch panel 11 in the present embodiment, that is, the bonding part 12, includes the bonding layer 121a, which is bonded over an entirety of the surface of the display panel 13, and the bonding layer 121b, which is bonded to the back surface of the touch panel 11 and has an area approximately equal to that of the bonding layer 121a. Further, the bonding part 12 includes the support member 122, which is interposed between the bonding layer 121a and the bonding layer 121b, and supports an approximate entirety of the lower end part of the touch panel 11. With this configuration, even if the bonding intensity of the touch panel 11 decreases, the lower end part of the touch panel 11 supported by the support member 122 makes it possible to prevent the touch panel 11 from being displaced in the gravity direction (in the Z axis negative direction), as compared with the configuration in which the touch panel 11 and the display panel 13 are bonded to each other simply with a bonding layer.

### Embodiment 2

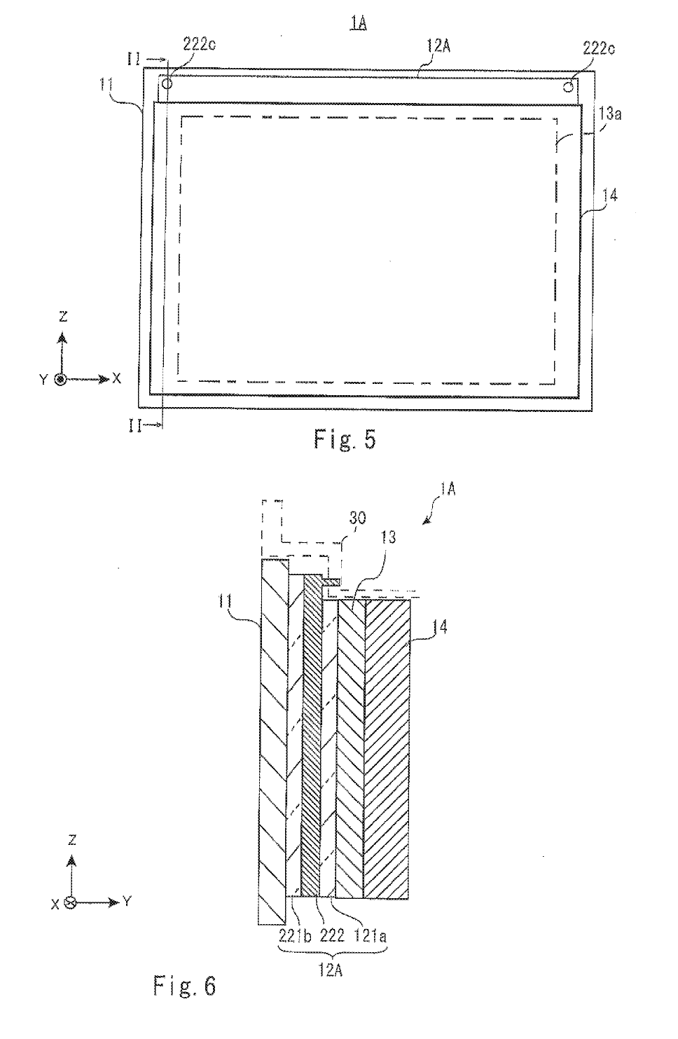

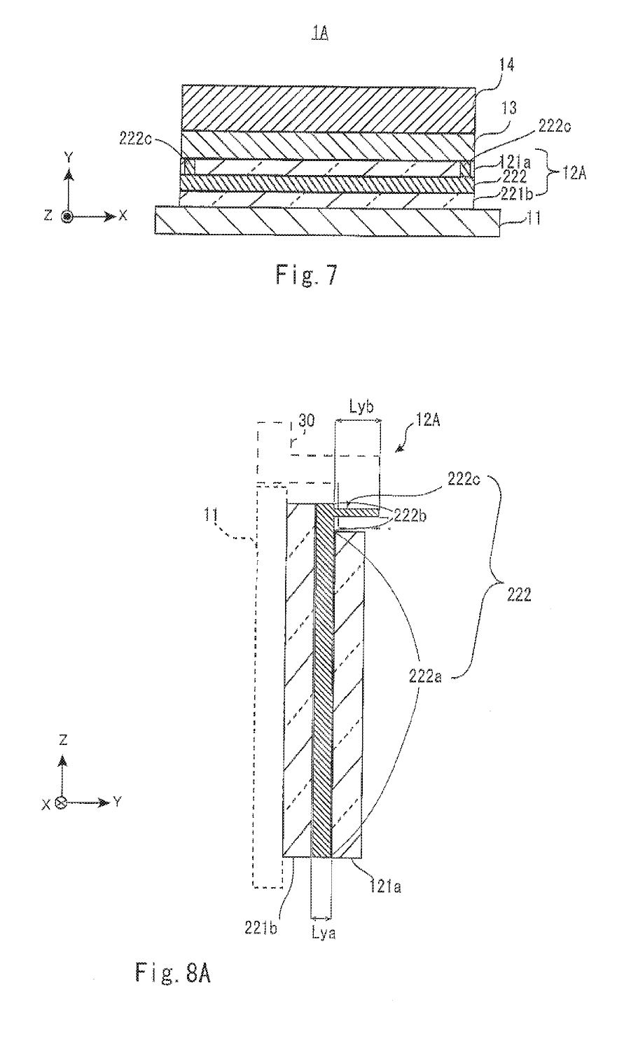

FIGS. 5 to 7 are schematic diagrams illustrating a schematic configuration of a touch-panel-equipped display device according to Embodiment 2. FIG. 5 is a schematic diagram illustrating a back surface of the touch-panel-equipped display device according to the present embodiment. FIG. 6 is a schematic diagram illustrating a cross section of the touch-panel-equipped display device 1A illustrated in FIG. 5, taken along line II-II. FIG. 7 is a schematic diagram illustrating a top surface of the touch-panel-equipped display device 1A illustrated in FIG. 5. In each drawing, the configurations identical to those in Embodiment 1 are denoted by the same reference symbols as those in Embodiment 1. In this example, the posture of the touch-panel-equipped display device 1A illustrated in FIG. 6 is a posture of the same in a state in which it is usually used.

The touch-panel-equipped display device 1A in the present embodiment is different from the touch-panel-equipped display device in Embodiment 1 in the point that it includes a bonding part 12A illustrated in FIGS. 5 to 7 in place of the bonding part 12. The following description describes the bonding part 12A specifically, while referring to FIGS. 5 to 7.

As illustrated in FIG. 6, the bonding part 12A includes a bonding layer 221b and a support member 222, in addition to a bonding layer 121a that is identical to that in Embodiment 1.

As illustrated in FIGS. 6 to 7, while the bonding layer 221b in the bonding part 12A has a length in the horizontal direction (in the X axis direction) that is approximately the same as that of the bonding layer 121a, it has a length in the vertical direction (in the Y axis direction) that is greater than that of the bonding layer 121a, whereby the bonding layer 221b has an area greater than that of the bonding layer 121a. Incidentally, each of the bonding layers 121a, 221b in the present embodiment has a thickness of about 1.0 mm.

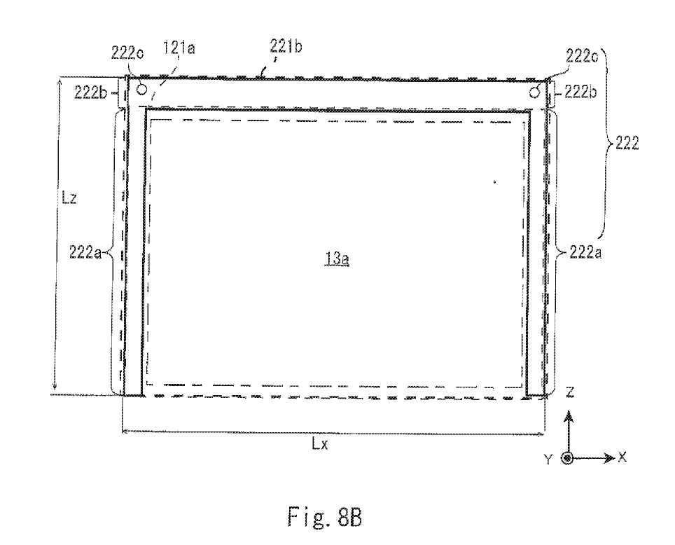

As illustrated in FIG. 6, a part of the support member 222 is interposed between the bonding layer 121a and the bonding layer 221b, and the support member 222 is fixed to an exterior part 30 of the touch-panel-equipped display device 1A. More specifically, the support member 222 includes an interposed part 222a, an extension part 222b, and support parts 222c, as illustrated in FIG. 8A.

The interposed part 222a is interposed between the bonding layer 121a and the bonding layer 221b. The extension part 222b is extended from an upper end of the interposed part 222a in the Z axis positive direction. In this example, the total length in the vertical direction (in the Z axis direction) of the interposed part 222a and the extension part 222b is approximately equal to that of the bonding layer 221b. The support parts 222c are connected with the extension part 222b, and protrude toward the bonding layer 121a (in the Y axis positive direction). In this example, as illustrated in FIGS. 5 to 7, the support member 222 includes two support parts 222c on both ends in the X axis direction, respectively, and each support part 222c has a circular cross-sectional shape. Each support part 222c is fit in an opening provided in the exterior part 30, so as to be fixed to the exterior part 30.

This example is an example in which two support parts 222c each of which has a circular cross-sectional shape are provided, but the number and shape of the support parts 222c are not limited to this case. For example, the support part 222c may have a rectangular or polygonal cross-sectional shape. Further, two or more support parts 222c may be provided in the support member 222, or one support part 222c continuously extended in the X axis direction may be provided in the support member 222. In short, the support part 222c may have such a shape that it can be fit in the exterior part 30. Further, in this example, the total length of the interposed part 222a and the extension part 222b in the vertical direction (in the Z axis direction) is approximately equal to the length of the bonding layer 221b, but the length thereof in the vertical direction may be greater than that of the bonding layer 221b, as long as the support member 222 can be fit in the exterior part 30.

FIG. 8B is a schematic diagram of the support member 222 illustrated in FIG. 8A, viewed in the Y axis positive direction. Each part of the support member 222 is arranged in an area outside the display area 13a of the display panel 13. In this example, the support member 222 has a length Lx in the X axis direction of about 170 mm, and a length Lz in the Z axis direction of about 105 mm. Further, in FIG. 8A, the interposed part 222a and the extension part 222b have a length Lya in the Y axis direction of about 0.6 mm, and each support part 222c has a length Lyb in the Y axis direction of about 2.5 mm.

The bonding mechanism for bonding the display panel 13 and the touch panel 11 in the present embodiment, that is, the bonding part 12A, includes the bonding layer 121a, which is bonded over an entirety of the surface of the display panel 13, and the bonding layer 221b, which is bonded to the back surface of the touch panel 11 and has an area larger than that of the bonding layer 121a. Further, the bonding part 12A includes the support member 222 interposed between the bonding layers 121a, 121b, and the support parts 222c in the support member 222 are fit in the exterior part 30, whereby the support member 222 is fixed to the exterior part 30. In the present embodiment, since the area where the bonding layer 221b is bonded to the back surface of the touch panel 11 is larger than that in Embodiment 1, the bonding intensity of the touch panel 11 improves, as compared with Embodiment 1. Further, since the touch panel 11 is fixed to the exterior part 30 with the bonding layer 221b and the support member 222 being interposed therebetween, even if the bonding intensity between the support member 222 and the bonding layer 121a decreases, the touch panel 11 is hardly displaced in the gravity direction (the Z axis negative direction).

### Embodiment 3

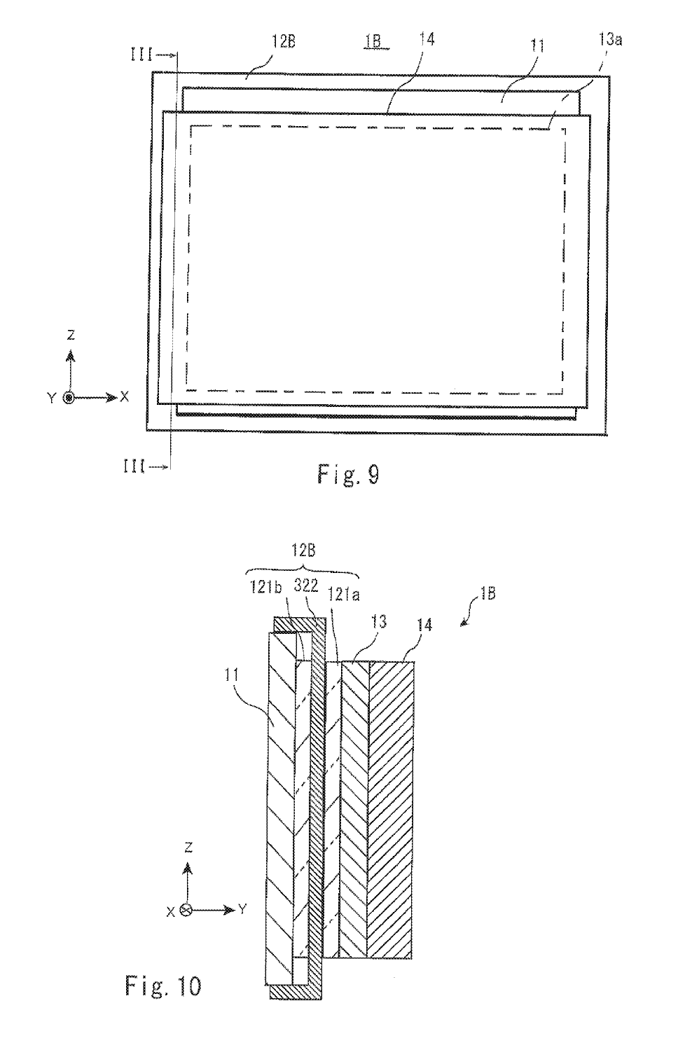

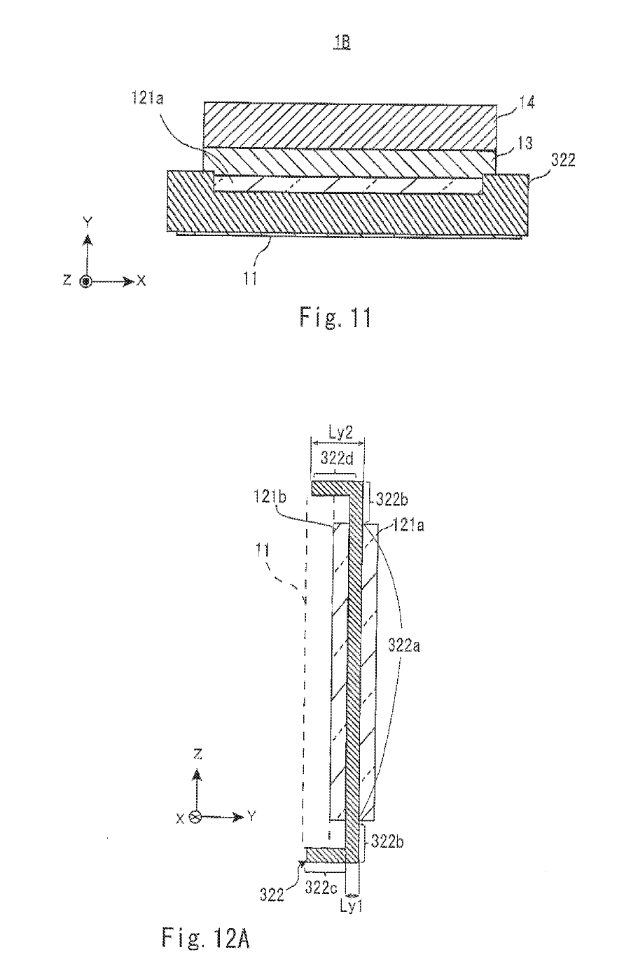

FIGS. 9 to 11 are schematic diagrams illustrating a schematic configuration of a touch-panel-equipped display device according to Embodiment 3. FIG. 9 is a schematic diagram illustrating a back surface of the touch-panel-equipped display device according to the present embodiment. FIG. 10 is a schematic diagram illustrating a cross section of the touch-panel-equipped display device 1B illustrated in FIG. 9, taken along line III-III. FIG. 11 is a schematic diagram illustrating a top surface of the touch-panel-equipped display device 1B illustrated in FIG. 9. In each drawing, the configurations identical to those in Embodiment 1 are denoted by the same reference symbols as those in Embodiment 1. In this example, the posture of the touch-panel-equipped display device 1B illustrated in FIG. 10 is a posture of the same in a state in which it is usually used.

The touch-panel-equipped display device 1B according to the present embodiment is different from the touch-panel-equipped display device in Embodiment 1 in the point that it includes a bonding part 12B illustrated in FIGS. 9 and 10 in place of the bonding part 12 in Embodiment 1. The following description describes the bonding part 12B specifically, while referring to FIGS. 9 to 11.

As illustrated in FIG. 10, the bonding part 12B includes a support member 322 that functions as a frame for the touch panel 11, in addition to bonding layers 121a, 121b that are identical to that in Embodiment 1. As illustrated in FIG. 10, a part of the support member 322 is interposed between the bonding layer 121a and the bonding layer 121b, and the support member 322 supports an approximate entirety of an upper end part (a part in the Z axis positive direction) of the touch panel 11, and an approximate entirety of a lower end part (a part in the Z axis negative direction) of the same, in such a manner that the support member 322 covers the outer edge of the touch panel 11.

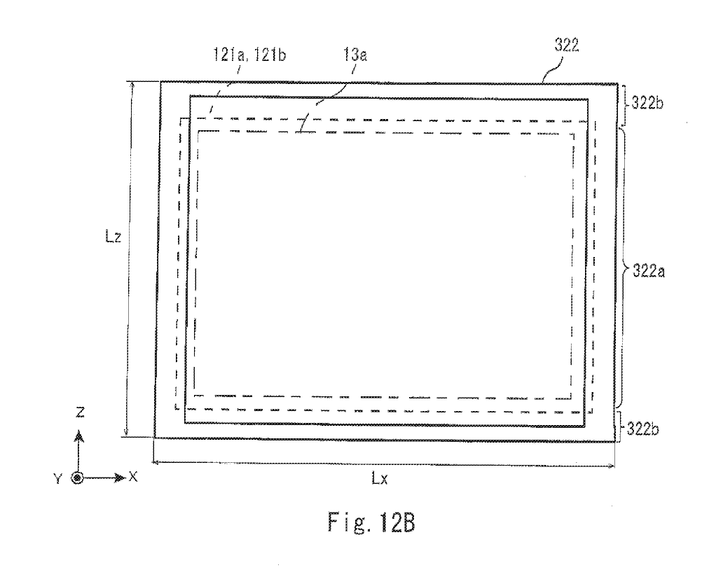

As illustrated in FIG. 12A, the support member 322 includes an interposed part 322a, extension parts 322b, and support parts 322c, 322d. The interposed part 322a is interposed between the bonding layer 121a and the bonding layer 121b. The extension parts 322b are extended from both ends of the interposed part 322a in the Z axis positive direction and the Z axis negative direction, respectively. The support part 322c is connected to the extension part 322b on the lower end side, and is extended toward the lower end part (the end in the Z axis negative direction) of the touch panel 11, so as to support an approximate entirety of the lower end part of the touch panel 11. Further, the support part 322d is connected to the extension part 322b on the upper end side, and is extended toward the upper end part (the end in the Z axis positive direction) of the touch panel 11, so as to support an approximate entirety of the upper end part of the touch panel 11.

FIG. 12B is a schematic diagram of the support member 322 illustrated in FIG. 12A, viewed from the Y axis positive direction. The interposed part 322a is arranged in an area outside the display area 13a of the display panel 13, between the bonding layers 121a and 121b. Further, the extension part 322b and the support parts 322c, 322d are arranged outside the bonding layers 121a, 121b. In this example, the support member 322 has a length Lx in the X axis direction of about 190 mm, and a length Lz in the Z axis direction of about 120 mm. Further, in FIG. 12A, the interposed part 322a has a length Ly1 in the Y axis direction of about 0.6 mm, and the extension part 322b and the support part 322c or 322d have a total length Ly2 in the Y axis direction of about 2.5 mm. Still further, a part including the bonding layers 121a, 121b has a dimension in the Y axis direction of about 1.0 mm. The configuration may be such that the part of the support member 322 covering the outer edge of the touch panel 11, that is, the part that is visible, is formed with an ABS resin (containing acrylonitrile, butadiene, and styrene), and the other part is formed with polycarbonate (PC).

The bonding mechanism for bonding the display panel 13 and the touch panel 11 in the present embodiment, that is, the bonding part 12B, includes the bonding layer 121a, which is bonded over an entirety of the surface of the display panel 13, and the bonding layer 121b, which is bonded to the back surface of the touch panel 11. Further, the bonding part 12B includes the support member 322, which is interposed between the bonding layer 121a and the bonding layer 121b, and supports the upper end part and the lower end part of the touch panel 11. With this configuration, even if the bonding intensity of the touch panel 11 decreases, the upper end part and the lower end part of the touch panel 11 supported by the support member 322 makes it possible to prevent a positional displacement in the gravity direction (in the Z axis negative direction) from occurring to the touch panel 11.

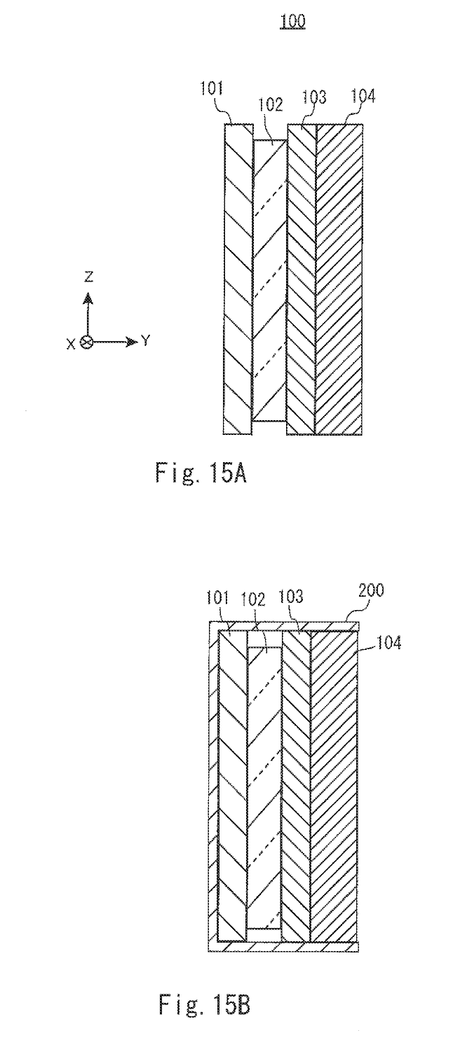

As illustrated in FIG. 15B, in a case where the outer edge of the touch panel is covered with the exterior part in the conventional structure in which the touch panel and the display panel are bonded to each other with the bonding layer alone, dimensional tolerances of the touch panel, the display panel, the backlight, and the exterior part have to be taken into consideration; otherwise, clearances between these and the exterior part tend to increase. In the present embodiment, only dimensional tolerances of the touch panel 11 and the support member 322, and adhesion deviation tolerances of the bonding layers 121a, 121b may be taken into consideration, which allows the clearance between the touch panel 11 and the support member 322 can be reduced to a minimum.

### Modification Examples

The embodiments disclosed herein should be considered to be illustrating in all respects, and not limiting. The scope of the present invention is indicated, not by the above descriptions of the embodiments, but the scope of claims, and is intended to encompass meanings equivalent to the scope of claims, and all modifications within the scope. The following description describes the modification examples.

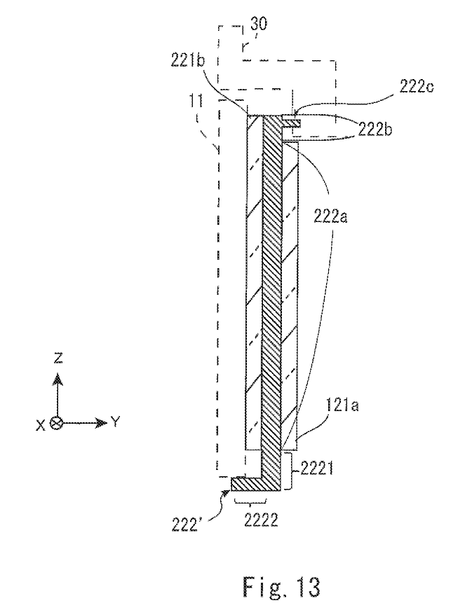

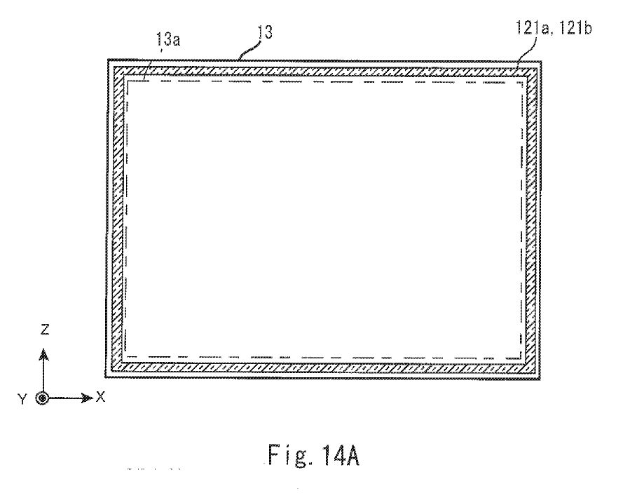

(1) The support member 222 in Embodiment 2 described above may have a configuration like a support member 222′ illustrated in FIG. 13. More specifically, as illustrated in FIG. 13, the support member 222′ includes a second extension part 2221 and a second support part 2222, in addition to the interposed part 222a, the extension part 222b (hereinafter referred to as a first extension part), and the support part 222c (hereinafter referred to as a first support part). The second extension part 2221 is extended in the Z axis negative direction from the lower end part of the interposed part 222a. The second support part 2222 is connected to the second extension part 2221, and is extended toward the lower end of the touch panel 11, so as to support the lower end part of the touch panel 11. In other words, in the present modification example, the support member 222′ is fixed to the exterior part 30 by the first support part 222c, and the lower end of the touch panel 11 is supported by the second support part 2222. This causes the touch panel 11 to hardly have a positional displacement in the gravity direction, as compared with the bonding structure of Embodiment 2.

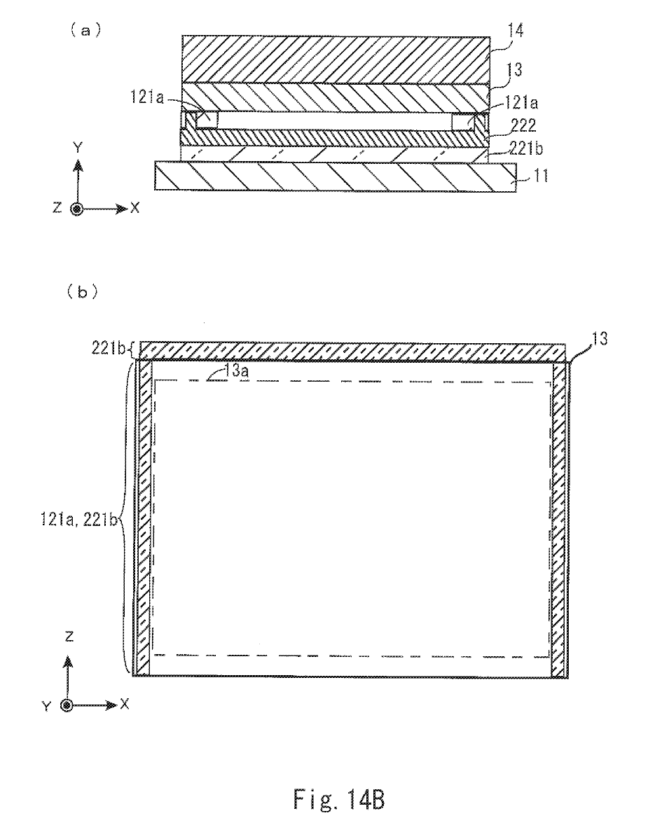

(2) As an example of the bonding layer 121a in Embodiments 1 to 3 described above and the bonding layer 121b in Embodiments 1, 3, a bonding layer having an area approximately equal to that of the display surface of the display panel 13 is described above, but the range where the bonding layers 121a, 121b are provided is not limited to this. For example, the configuration may be as follows: Embodiment 1 may be modified so that the bonding layers 121a, 121b are not provided on an inner side of the display area 13a, but is provided so as to surround the outer sides of the display area 13a, as illustrated in FIG. 14A. Alternatively, for example, the configuration may be as follows: Embodiment 2 may be modified so that the bonding layer 121a is provided only on the right and left sides outside the display area 13a, that is, in an area where the support member 222 is interposed, as illustrated in (a), (b) of FIG. 14B. The bonding layer 221b may be provided on the right and left ends and the upper end outside the display area 13a. In short, the first bonding layer bonded to the display panel and the second bonding layer bonded to the touch panel may be arranged on an inner side with respect to the outer edge of the display panel, and on an outer side with respect to the display area.

1. A touch-panel-equipped display device comprising:
a display panel;
a touch panel arranged so as to be opposed to the display panel; and
a bonding mechanism for bonding the display panel and the touch panel to each other,
wherein the bonding mechanism includes:
a first bonding layer that has translucency and is bonded on a surface of the display panel, the surface being opposed to the touch panel;
a second bonding layer that has translucency and is bonded on a surface of the touch panel, the surface being opposed to the display panel; and
a support member that is interposed between the first bonding layer and the second bonding layer, and supports the touch panel.

2. The touch-panel-equipped display device according to claim 1,
wherein the support member includes:
an interposed part that is interposed between the first bonding layer and the second bonding layer, outside a display area of the display panel;
an extension part that is not interposed between the first bonding layer and the second bonding layer, and is extended from an end of the interposed part; and
a support part that is connected to the extension part, and supports at least a lower end of the touch panel.

3. The touch-panel-equipped display device according to claim 1,
wherein a length of the second bonding layer in one direction of the touch panel is greater than that of the first bonding layer, and
the support member includes:
an interposed part that is interposed between the first bonding layer and the second bonding layer, in an area outside a display area of the display panel;
an extension part that is not interposed between the first bonding layer and the second bonding layer, and is extended from an end of the interposed part in the one direction; and
a support part that is connected to the extension part, and has a protrusion combined with an external component.

4. The touch-panel-equipped display device according to claim 1,
wherein the first bonding layer and the second bonding layer are provided on an inner side with respect to an outer edge of the display panel, outside a display area of the display panel.

5. The touch-panel-equipped display device according to claim 1,
wherein the display panel includes a liquid crystal layer,
the touch-panel-equipped display device further comprising:
a light source that is bonded on a surface of the display panel, the surface being on a side opposite to the touch panel, the light source irradiating the display panel with light.

6. The touch-panel-equipped display device according to claim 1,
wherein the touch panel includes a light-shielding part on the surface thereof opposed to the display panel, in an area on an outer side with respect to the display area of the display panel.
